(19) United States
(12) Patent Application Publication
(10) Pub. No.: US 2004/0218269 A1
(43) Pub. Date: Nov. 4, 2004

(54) General purpose stereoscopic 3D format conversion system and method

(76) Inventors: Adam W. Divelbiss, Wappingers Falls, NY (US); Walter V. Tserkovnyuk, Yonkers, NY (US)

Correspondence Address: REVEO, INC., 85 EXECUTIVE BOULEVARD, ELMSFORD, NY, 10523, US

(21) Appl. No.: 10/759,393

(22) Filed: Jan. 16, 2004

Related U.S. Application Data
(63) Continuation-in-part of application No. 10/045,901, filed on Jan. 14, 2002.
(60) Provisional application No. 60/440,512, filed on Jan. 16, 2003.

(51) Int. Cl. G02B 27/22

(52) U.S. Cl. 359/464

(57) ABSTRACT

Because of the numerous possibilities in the capture, transmission, and display of stereoscopic image pairs during 3D format conversion, there are numerous compatibility issues between the various stereoscopic image sources and stereoscopic display systems. A general purpose stereoscopic 3D format conversion system and method is described that eliminates these compatibility issues by providing a system that performs conversion of any stereoscopic image stream within a specified set of 3D formats to any other 3D format within the set. The system also performs numerous other image processing functions that are beneficial for stereoscopic image processing such as image pan, alignment, zoom, crop, keystone correction, video format conversion, scan-rate conversion, and an array of standard 2D image enhancements including brightness, contrast, hue saturation, and sharpness.

### RELATED APPLICATIONS

The instant application is a Continuation-in-Part of U.S. application Ser. No. 10/045,901 entitled “Method and Apparatus for Stereoscopic Display Using Column Interleaved Data with Digital Light Processing” filed on Jan. 14, 2002, and claims priority to U.S. Provisional Application No. 60/440,512 entitled “A General Purpose Stereoscopic 3D Format Conversion System and Method” filed on Jan. 16, 2003.

### FIELD OF INVENTION

The invention pertains to format conversion of 3D formats and in particular to a device and methods of in a 3D format conversion that performs conversion of any stereoscopic image stream within a specific set of 3D to any other 3D format within the set.

### BACKGROUND

Over the last two decades, numerous stereoscopic 3D display and recording devices have been developed for a variety of purposes and a variety of customers. One of the main questions that must be answered during the development of such devices concerns which method will be used to capture, encode, and/or display stereo image pairs. All stereoscopic display devices require the presentation of a left-eye image to the left eye of each observer and a right-eye image to the right eye of each observer. The method used to capture, transmit, or display such images depends on many factors including the type of display or recording system and the method by which the image pair will be presented. For instance the stereoscopic shutter glass systems typically require a time-multiplexed sequence of left-right image pairs to be transmitted to a CRT monitor. Other display systems (such as those based on the Reveo micropol) present the stereoscopic image pairs in an alternating row format (row-interleaved) such that, for example, odd lines of the display (and the transmitted image) contain the left-eye image while even lines contain the right-eye image. Still other displays and recording devices have utilized other 3D formats including over-under, side-by-side, column-interleaved, and dual-channel (physically separated channels). There are even more 3D image formats that involve encoding left-right image pairs on different color channels of the transmission signal or within non-overlapping spectral regions of light.

Because of these numerous possibilities in the capture, transmission, and display of stereoscopic image pairs, it should be easy to understand that there are numerous compatibility issues between the various image sources and display systems.

There are numerous systems that have various portions of the capabilities of the present invention. None of them, however, offer the range of flexibility and versatility of the present invention in a single device. There are far too many devices to mention here, however www.stereo3d.com keeps a fairly up-to-date list of the latest 3D recording and display devices as well as converter boxes.

Existing stereoscopic format converters come in the form of what are termed 3D multiplexers or 3D demultiplexers. A 3D multiplexer takes two separate video image streams and multiplexes them together into a single video stream on a frame-by-frame basis for progressive video or field-by-field basis for interlaced video. In terms of the present invention these devices perform a dual-channel to field or frame-sequential conversion. Alternatively 3D demultiplexers perform the reverse operation in that they separate 3D image data encoded frame-by-frame or field-by-field in a single video image stream into two separate streams. In terms of the present invention these devices perform a field or frame-sequential to dual-channel conversion. Usually these devices are built for a specific video format (e.g., NTSC or PAL video, or computer VGA formats). Some examples of such devices include the following.

VRex 3D Format Converter 1.0—The 3D Format Converter 1.0 is an instantiation of the predecessor of the present invention. It has the capability of receiving only field-dequential 3D video from a composite video or S-Video source in both NTSC or PAL formats and converting that video to a single 3D format for computer VGA video on the output. The device could be configured to output 2D, dual-channel, frame-sequential, field-sequential, row-interleaved, or column-interleaved but only at the time of manufacture. It was not possible for the user to change between the various 3D output formats.

VRex MUX-1—The MUX-1 is a 3D video multiplexer that converted two separate NTSC video signals into a single NTSC video signal using the field-sequential 3D format. The two input signals must be genlocked. In the present invention it is not necessary to have genlocked or co-synchronized input signals.

VRex MUX-3—The MUX-3 is the same thing as the MUX-1 except that it supported the PAL video standard.

Cyviz, Inc.—Cyviz (a Norwegian company) that produces two 3D format conversion products, xpo.1 and xpo.2. Each of these products is a 3D video demultiplexer that converts frame-sequential computer video formats to dual-channel format of the same resolution at half the vertical refresh rate on the output. These products have some advanced features including stereoscopic edge blending that is useful for merging two or more projection screens together. More information can be found at www.cyviz.com.

3DTV-3DTV has several lines of 3D Video multiplexers and video format converters. More information can be found at www.3dmagic.com.

Dimension Technologies (DTI) has a line of auto stereo displays that is capable of receiving numerous 3D formats for display on their device. Most 3D display devices accept a single 3D format that is required to experience any sense of depth at all. More information on the DTI display can be found at www.dti3d.com.

2D scan converters are devices that convert one video format to another (e.g., NTSC to PAL, or computer format to NTSC, etc.) A 2D scalar changes the image resolution of the signal up or down to match the desired output. There are numerous 2D scan converters on the market including those sold by RGB Spectrum (www.rgb.com) and Extron (www.extron.com).

Thus, it is apparent that the proliferation of 3D stereoscopic display and recording systems has resulted in a wide variety of stereoscopic 3D image formats (also referred to as 3D formats). Because these display formats vary greatly from one another and do not typically lend themselves to easy conversion from one to another, there are great opportunities for incompatibility between stereoscopic image generation systems and stereoscopic display systems. There are numerous devices that may perform a conversion between two different 3D formats (typically field or frame sequential to dual-channel or dual-channel to field or frame sequential). However a need still remains in the art for a general-purpose device that is capable of conversion form any 3D format to any other 3D format.

### SUMMARY

The above-discussed and other problems and deficiencies of the prior art are overcome or alleviated, and the objects of the invention are attained, by the several methods and systems of the present invention.

The general purpose stereoscopic 3D format conversion system and method described herein eliminates these compatibility issues by providing a system that performs conversion of any stereoscopic image stream within a specified set of 3D formats to any other 3D format within the set. The system also performs numerous other image processing functions that are beneficial for stereoscopic image processing such as image pan, alignment, zoom, crop, keystone correction, video format conversion, scan-rate conversion, and an array of standard 2D image enhancements including brightness, contrast, hue saturation, and sharpness.

Thus, the invention described herein permits the user perfect freedom to connect any known stereoscopic image generation or recording system to any known stereoscopic image display device while providing useful image enhancements.

### DESCRIPTION OF THE DRAWINGS

These and other features, aspects, and advantages of the present invention will become better understood with regard to the following, appended claims, and the accompanying drawings where:

FIG. 1 illustrates a block diagram of an embodiment of a stereoscopic 3D format converter;

FIG. 2 illustrates a block diagram of a front-end processor system with digital RGB outputs;

FIG. 3 illustrates a block diagram of a front-end processor system with digital YUV outputs;

FIG. 4 illustrates a block diagram of a back end processor with digital RGB inputs;

FIG. 5 illustrates a block diagram of a back end processor system with digital YUV inputs;

FIG. 6 illustrates a block diagram of a 48 bit digital RGB-CHVF input data bus;

FIG. 7 illustrates a block diagram of a 60 bit digital RGB-CHVF output video data bus;

FIG. 8 illustrates a block diagram of a 16 bit digital YHVF video data bus;

FIG. 9 illustrates a block diagram of one embodiment of a 3D data format converter; and

FIG. 10 illustrates a block diagram of another embodiment of the 3D data formatter.

### DETAILED DESCRIPTION

The methods and systems herein convert any 3D format from a large set of 3D formats to any other 3D format in a single electronics device. The base set of 3D formats supported by the preferred embodiment include: standard 2D; dual-channel; field-sequential; frame-sequential (page-flipped); over-under; row-interleaved; side-by-side; and column-interleaved. Other potential 3D formats may be supported, including but not limited to spectrally multiplexed formats using this device. Furthermore, embodiments described herein provide many other useful features for the proper setup, enhancement, and correction of dual or multiplexed stereoscopic image streams. These features include stereoscopic image pan, alignment, crop, zoom, keystone correction, aspect ratio conversion, and both linear and non-linear scaling. Furthermore, since stereoscopic images are transmitted on a wide variety of standard video interfaces, the invention described herein supports conversion from one video interface to another. Video interfaces supported by the preferred embodiment include RGB computer, component video, S-Video, and composite video. The various video standards for each video interface are also supported by a preferred embodiment including VESA GTF standards, HDTV standards, NTSC, PAL, SECAM, YUV and RGB video, etc. Furthermore, since certain embodiments of the invention described herein are constructed, in part, using state-of-the-art FPGA (field programmable gate array) technology, new functions, features, and 3D formats may be added to the device in the future as new problems and needs are discovered. The format conversion and the other image processing functions may be in real-time for superior performance (as opposed to frame by frame format conversion and the other image processing typically used as editing systems).

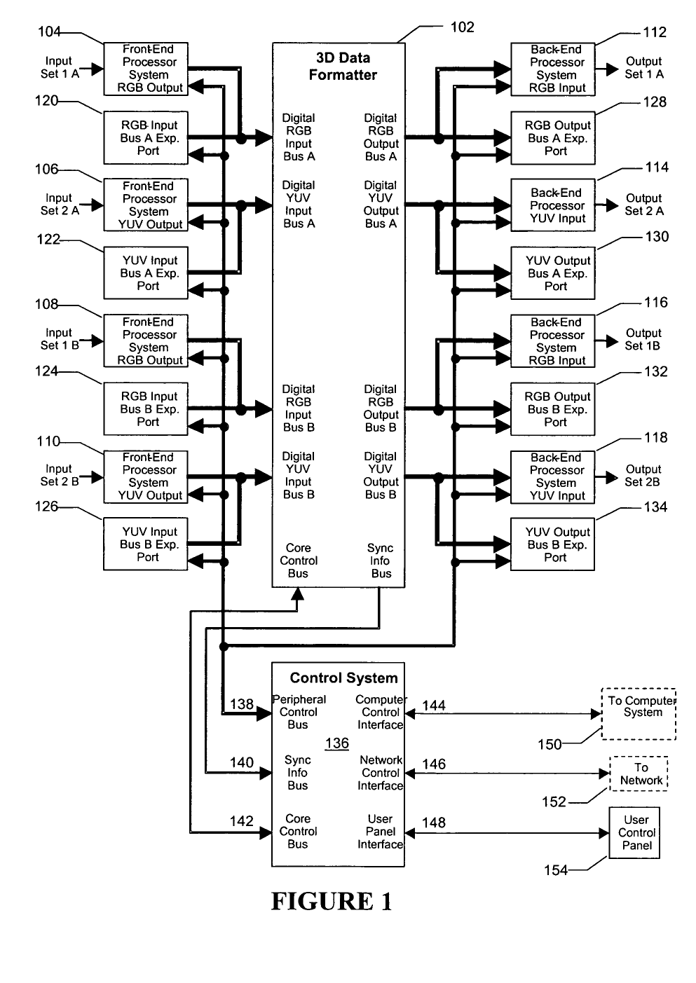

The basic system architecture of the present invention is illustrated in FIG. 1. A 3D data formatter 102 performs several major functions including input channel selection, stereoscopic demultiplexing, stereoscopic image scaling, scan rate conversion, stereoscopic 3D format conversion and output channel selection. Based on input selection settings, the 3D data formatter 102 chooses which of the plural input channels to use for 3D stereoscopic input. Typically only one or two channels will be chosen at a time depending on which 3D format is being input. Next the 3D data formatter 102 demultiplexes or separates 3D stereoscopic data into two separate image-processing channels. It is extremely important that this separation step be performed so that the left-perspective image data and right-perspective image data may be processed separately. Processing the channels together as one data frame will cause corruption of the data during the image scaling and scan conversion processes. Next the 3D data formatter 102 performs an image scaling operation to adjust the image resolution to that required by the selected output. Depending on the data format chosen for output signal, the 3D data formatter 102 may perform a scan conversion of the image data. If the output data format is input synchronized no scan conversion is performed. This is the case where the input data signal frame rate controls the internal data frame rate of the system and where the 3D output rate is directly controlled by the input signal. If the output data format is output synchronized, a scan rate conversion is performed to synchronize the processed 3D image data with the desired output frame rate. In this case the 3D output rate is completely independent of the input signal frame rate. There are advantages and disadvantages for both methods. Finally the 3D data formatter 102 performs a 3D stereoscopic format conversion to recombine the processed stereoscopic image data into the format required by the output. The present system accommodates a large number of input/output types and allows independent operation of the internal stereo channels as is described below.

Another prominent feature of the 3D data formatter 102 is the fact that it supports two input signal groups (A and B as shown in FIG. 1) and two output signal groups. Each input or output may support any of the multiplexed 3D formats, regardless of group identification.

The signal groups are significant to provide support for non-multiplexed (dual-channel) 3D formats. One input or output from each group (A and B) is selected for each channel. This means simply that two inputs in the same group cannot be used for dual-channel 3D formats. However any signal pair consisting of signals from opposite groups is valid and supported. This results in the possibility that images on dissimilar video interfaces (e.g., VGA computer and composite video) can make a valid stereo pair.

Each signal group is subdivided into two sets based on the digital image data format used to transmit the raw images to or from the 3D data formatter 102. These two sets include digital RGB input/output and digital YUV input/output. In FIG. 1, these sets are represented by the fact that input group A contains a digital RGB input bus A, and a digital YUV input bus A. A similar arrangement is made for each of the other three signal groups (Input B, Output A and Output B) as is shown in FIG. 1. Accommodation is made for both types since both types are used by the various image interface electronics extant (e.g., triple ADCs and DACs, video decoders/encoders, HDTV decoders/encoders, etc.). Each individual digital RGB or digital YUV bus is capable of supporting virtually any number of compatible devices. Digital input buses are limited to only one active input at a time. All input devices within the front-end processors, except the active devices, preferably have tri-state outputs to avoid corruption of input data. However, for the output buses, any device capable of supporting the current signal timings may be active since no data corruption will occur.

Surrounding the 3D data formatter 102 are peripheral processor systems. The various front-end processor systems 104, 106, 108, 110 on the left side of FIG. 1 receive image data in various formats from the outside and convert the data to either digital RGB or digital YUV depending on the input bus to which they are attached. Likewise the various back-end processor systems 112, 114, 116, 118 on the right side of FIG. 1 receive image data from the 3D data formatter 102 in either digital RGB or digital YUV format and convert that data to the various video image standards for transmission to the outside. In addition to a processor system, each digital RGB or digital YUV bus has an attached expansion port. The expansion ports 120, 122, 124, 126, 128, 130, 132, 134 are systems that allow other input or output devices to be added to the system after-the-fact. In this way, when new video standards are developed by the industry, an expansion card can be added to support the new format. Alternatively, if there is a currently existing video data format that is not supported by a preferred embodiment, an expansion card can be developed and added to the system. Further, the expansion ports 120, 122, 124, 126, 128, 130, 132, 134 may be used to support serial, USB, network, or other non-video interfaces to allow streaming video to be stored and/or transmitted over a local or external network.

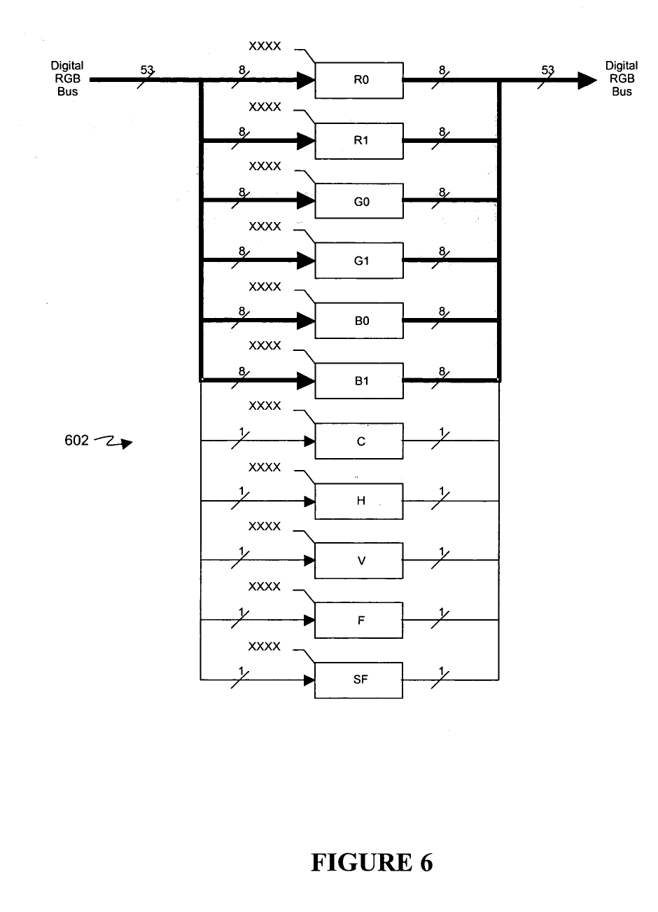

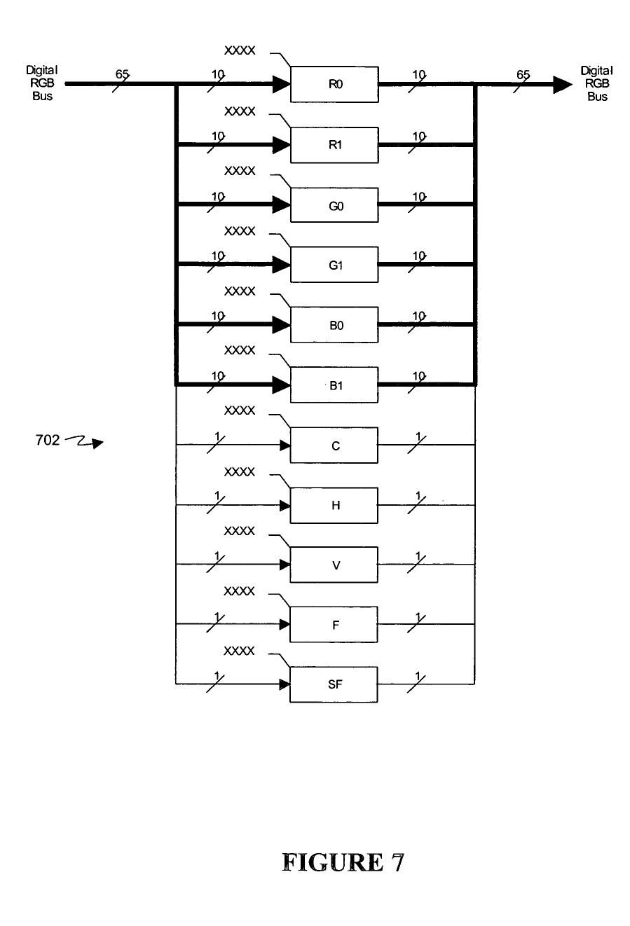

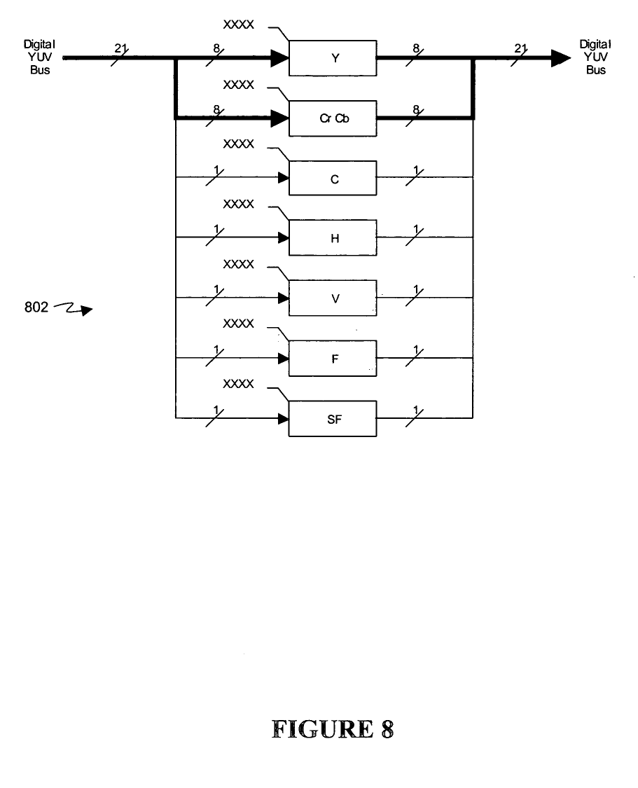

The front-end processor systems 104, 108 with RGB output each represent a group of standard image input electronics that may share the same digital RGB input bus protocol (e.g., as shown herein at FIGS. 6 and 7). Likewise the two front-end processor systems 106, 110 with YUV output each represents a group of standard image input electronics that share the same digital YUV input bus interface protocol (e.g., as shown herein at FIG. 8). Standard inputs in the preferred embodiment include RGB computer, HDTV, composite video, Y/C video, and component video. Other possible inputs include SDI (serial digital interface) and DVI (Digital Video Interface).

Similarly the two back-end processor systems 112, 116 with RGB input each represent a group of standard image output electronics that share the same digital RGB output bus protocol (e.g., as shown herein at FIGS. 6 and 7) while the two back-end processor systems 114, 118 with YUV Input each represent a group of standard image output electronics that share the same digital YUV output bus interface protocol (e.g., as shown herein at FIG. 8). Standard outputs in the preferred embodiment include RGB computer, HDTV, composite video, Y/C video, and component video. Other possible inputs include SDI (serial digital interface) and DVI (Digital Video Interface).

In addition to their respective digital video interfaces with the 3D data formatter, each peripheral processor system 104-118 is controlled by a control system 136 through a peripheral control bus 138 that is common to all. In a preferred embodiment, the peripheral control bus 138 contains a two-wire serial bus that uses the patented I²C serial interface developed by Philips Semiconductor. This standard has become quite common among various video interface electronics. Additionally the peripheral control bus 138 contains plural dedicated general-purpose I/O lines that may be used as interrupt inputs to the control system 136, e.g., to obtain feedback from one or more front end processors and/or one or more of the back end processors.

The second most prominent feature illustrated in FIG. 1 is the control system 136, which includes a microcontroller and related support circuitry. In a preferred embodiment, the control system 136 contains six digital communication ports including the peripheral control bus 138 described above, a sync info bus 140, a core control bus 142, a computer control interface 144, a network control interface, 146 and a user panel interface 148. The control system 136 monitors and controls the 3D data formatter 102 through the core control bus 142 and the sync info bus 140. The sync info bus 140 provides information on the status of the input timing signals of the currently selected and active inputs. This connection allows the control system 136 to identify incoming video signals for proper setup of the 3D data formatter 102. The core control bus 142, in a preferred embodiment, is a three-wire serial interface with dedicated enable lines for each device within the 3D data formatter 102. The electronics devices within the 3D data formatter 102 have various methods of serial communication that are all different from one another. The core control bus 142 has been developed to accommodate each of these serial interface types. The computer control interface 144 may be any suitable interface to a computer system 150. For example, a standard serial communication interface system may be used. In a preferred embodiment this interface is realized using the RS-232 standard. A further embodiment may employ USB 2.0 or other similar standards. The purpose of the computer control interface 144 is to allow control status gathering of the device by the local computer system 150. New firmware for the various programmable components may also be uploaded through this interface 144. The network control interface 146 performs a similar function as the computer control interface 142, but allows the connection of the device to a network 152, such as a Local Area Network, through standard network interface circuits. Finally the user panel interface 148 allows communication between the main device and an optional user control panel 154, e.g., through a three-wire serial interface. The optional user control panel 154 allows local control over the device independent of any network 152 or computer system 150.

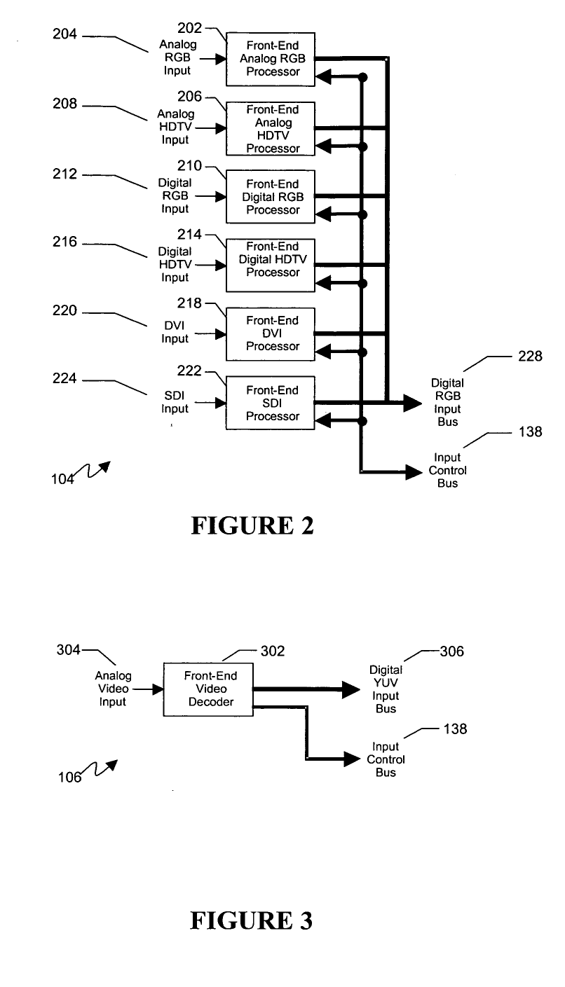

An embodiment of the front-end processor system 104 (or 108) with digital RGB outputs is illustrated in FIG. 2. The processor system 104 includes a collection of various hardware components that decode image data (using various connectors and standards) into the digital RGB format used by the 3D data formatter 102. FIG. 2 shows a sample collection of such hardware. A preferred embodiment uses a three-channel ADC and support hardware to convert various computer and HDTV formats, and a video decoder chip and support hardware to convert composite, Y/C, and component video. There are numerous other decoder chips that support a wide variety of video format inputs that could be used as indicated in the figure. The expansion ports allow new formats to be supported by the addition of extra peripheral circuit boards.

In the preferred embodiment a front-end analog RGB processing block 202 is implemented and supports the input of three separate analog color channels 204 (red, green, and blue) as well as two synchronization signals (vertical and horizontal) and a 3D field ID signal. Analog inputs are converted to a 48-bit RGB (alternatively 24-bit RGB) digital format for transmission to the 3D data formatter 102.

Other front-end processing blocks are shown in the figure. An analog HDTV processor 206 provides a dedicated connection for analog HDTV 208 using the YUV or RGBS format. A digital RGB processor 210 converts digital RGB data 212 in other bit-depths into the 48-bit depth used by the digital RGB input bus. A digital HDTV processor 214 provides a support for digital HDTV 216 formats. A DVI processor 218 provides support for a Digital Video Interface standard input 220. Finally the SDI processor 212 provides support for the Serial Digital Interface standard input 224. Each of these front-end processor blocks 202, 206, 210, 214, 218, 222 are connected to the 3D data formatter 102 via a digital RGB input bus 226 and to the control system 136 via the peripheral control bus 138.

An embodiment of the front-end processor system 106 (or 110) with digital YUV outputs is another collection of video input hardware components that output on of the several digital YUV standards instead of RGB. FIG. 3 illustrates only one component in this collection but others may be included as well. In a preferred embodiment, the front-end video decoder block 302 is capable of supporting three separate video input 304 formats, including composite video, Y/C-video, and component video (YUV or RGB). Many modern video decoder chips support this level of functionality. The front-end video decoder 302 block also handles analog-to-digital conversion (ADC) of the input video signals 304. Regardless of the input format, the output of the front-end video decoder block 302 is a digital version of the selected input. The 3D format of the input image data may take any of the standard forms. For video input signals the 3D format is typically field sequential 3D (left-right image data are transmitted on alternate fields of the video signal) or dual input 3D (left-right image data are input on two physically separate input connectors). Other optional functions of the front-end video processing blocks 302 include gain control, color and brightness control, video format decoding (NTSC, PAL, SECAM, etc.) and other features that may be associated with video signal decoding. The front-end video decoder 302 is connected to the 3D data formatter 102 via a digital YUV input bus 306 and to the control system 136 via the peripheral control bus 138.

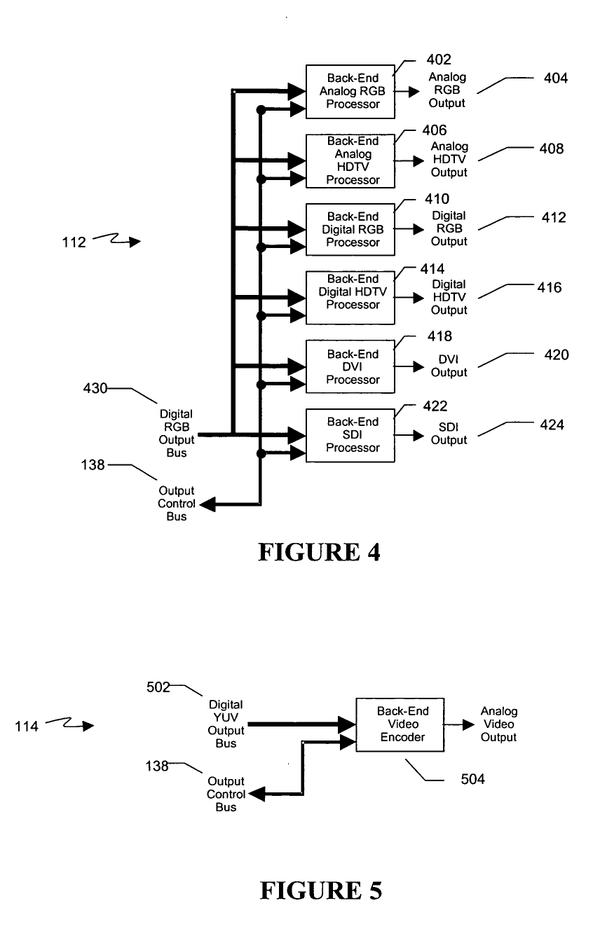

An embodiment of the back-end processor system 112 (or 116) with digital RGB inputs from bus 430 is shown in FIG. 4. This system 112 performs the inverse function of the front-end processor system in that it converts the digital RGB format used by the 3D data formatter 102 (shown as digital RGB output bus 430) into the various video formats available for output. This system is a collection of standard hardware components and support hardware that is used to perform the various conversions. The preferred embodiment uses a back-end analog RGB processor 402, e.g., implemented using a triple 10-bit DAC, for an analog RGB output 404. Both computer video standards and HDTV standards are supported by this hardware. FIG. 4 illustrates other hardware possibilities, including: back end analog HDTV processor 406 for an analog HDTV output 408; back end digital RGB processor 410 for an digital RGB output 412; back end digital HDTV processor 414 for a digital HDTV output 416; back end DVI processor 418 for a DVI output 420; back end SDI processor 422 for a SDI output 424; and other outputs. There are many other conversion hardware components that are available to implement the other blocks lists.

FIG. 5 illustrates details of the back-end processor system 114 (or 118) with digital YUV inputs 502. In a preferred embodiment only a back-end video encoder block 504 is used, although other hardware is certainly available. The back-end video encoder block 504 converts digital YUV data into any of the various analog video formats including composite, Y/C, component (YUV and RGB) in any of the NTSC, PAL, or SECAM video standards.

FIG. 6 illustrates a representation of a 48-Bit Digital RGB Input Video bus 602 used by the 3D data formatter 102. Using this bus system 602, either 24-bit or 48-bit RGB video data can be accommodated. In the 48-bit mode, two complete image pixels are sent in parallel to halve the bus speed requirements. R0 and R1 represent the first and second red pixel in the data stream. Likewise G0 and G1 represent the first and second green pixel and B0 and B1 represent the first and second blue pixel. Each of these color channels is 8-bits wide as shown. The other signals in the bus constitute the video timing and 3D field ID signals. C represents the pixel clock. H represents horizontal sync. V represents vertical sync. F represents the video field ID. SF represents the stereo field ID.

FIG. 7 illustrates a representation of a 60-bit digital RGB output video bus 702 used by the 3D data formatter 102. Using this bus system 702, 60-bit, 30-bit, 48-bit, or 24-bit RGB video data can be accommodated. In the 60-bit mode, two complete image pixels are sent in parallel to cut in half the bus speed requirements. R0 and R1 represent the first and second red pixel in the data stream. Likewise G0 and G1 represent the first and second green pixel and B0 and B1 represent the first and second blue pixel. Each of these color channels is 10-bits wide as shown. The other signals in the bus constitute the video timing and 3D field ID signals. C represents the pixel clock. H represents horizontal sync. V represents vertical sync. F represents the video field ID. SF represents the stereo field ID.

FIG. 8 illustrates a representation of the 16-Bit Digital YUV Bus 802 used by both the input and the output sides of the 3D Data Formatter. In 16-Bit YUV one 8-bit channel is used for luminance information while the second 8-bit channel is used for the chrominance information. Alternatively if one of the input or output processor systems requires an 8-bit YUV data format this bus system can accommodate both luminance and chrominance on one of the 8-bit channels. In the preferred embodiment 16-bit YUV in the 4:2:2 format is used to transmit data to and from the 3D data formatter 102. As in the other bus systems, C represents the pixel clock, H represents horizontal sync, V represents vertical sync, F represents the video field ID, and SF represents the stereo field ID.

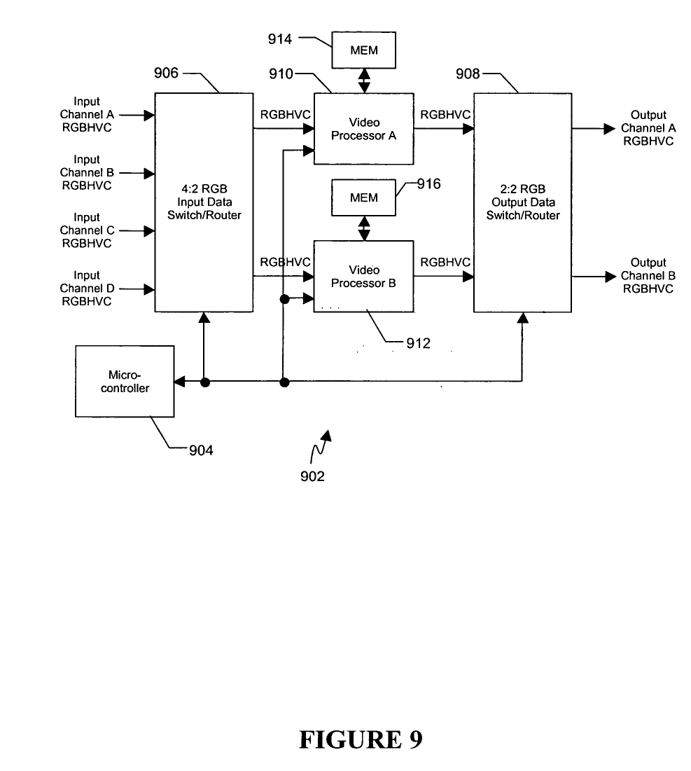

FIG. 9 depicts one embodiment of a 3D data formatter 902 (which may be used in certain embodiments as 3D date formatter 102 shown in FIG. 1). Certain functionalities of the 3D data formatter 902 are described in commonly owned U.S. application Ser. No. 10/045,901 and International Application PCT/US02/01314 published as WO/02/076107 both entitled “Method and Apparatus for Stereoscopic Display Using Column Interleaved Data with Digital Light Processing” and incorporated by reference herein. The 3D data formatter 902 performs five major functions including: input channel selection, stereoscopic demultiplexing, stereoscopic image scaling, scan rate conversion, and real time stereoscopic 3D format conversion. The 3D data formatter 902 includes five major components, including a microcontroller 904, a four input two output RGB input data switch/router system 906, a two input two output RGB output data switch/router system 908, and two separate video processing units 910, 912 with associated memory 914, 916. The dual video processor configuration enables various functionalities. In certain embodiments, this functionality includes independent image processing for both left- and right-perspective image data. The dual-processor configuration provides the highest-image quality available while preventing stereoscopic degradation by keeping left and right image data completely separate. In other embodiments, the dual video processor system enables simultaneous processing of video data for different output 3D formats or video formats.

The 4-to-2 RGB Input Data Switch/Router System is essentially a matrix switch for RGBHVC data signals that has the ability to route any input to any or both outputs depending on the 3D format of the input signal. For instance, in the case where Input Channel A contains both left and right perspective image data, the input switch 906 will route Input Channel A to both outputs for further manipulation by the video processors 910, 912. In the case that left and right perspective image data are carried on two separate channels, Channel A and Channel B for example, each input is routed to a single output. In a preferred embodiment this switch is implemented using a high-speed CPLD integrated circuit.

The two video processors 910, 912 are video processing circuits with the ability to perform many useful functions including: image resizing, scan rate conversion, color correction, and keystone correction. These processors also may control the position in memory of plural separate consecutive input image data frames and plural separate output data frames. These features make it possible for each video processor 910, 912 to operate on a specific set of image data corresponding to the left or right perspective image. Working in conjunction with the input data switch/router 904, virtually any 3D stereoscopic data format may be accommodated. Once the appropriate image data set has been isolated by the input frame controls, each video processor 910, 912 performs the required scaling and image enhancement operations. The video processors 910, 912 also act as dual port memory controls, whereby the output data rate may be independent of the input data rate. Input and output data rates are determined by the horizontal sync, vertical sync and pixel clock signals. Preferred embodiments of video processors 910, 912 are IP00C711 chips from iChips, Inc. Other video processor integrated circuit chips with similar functions and features may also be used. Preferred embodiments of memory 914, 916 are 16-megabit SDRAM devices. Sufficient memory is provided to accommodate plural complete frame buffers for each video processor 910, 912 corresponding to the plural frame controls (four as shown in FIG. 9). This configuration provides the maximum control and flexibility required for this system.

The 2-to-2 RGB output data switch/router 908 is another RGBHVC digital matrix switch that is capable of routing either input to either output in any possible combination. It is also capable of routing any color data associated with the two input channels to any color location of the two output channels. This feature allows the use of color sequential methods for 3D image encoding. This switch works together with the two video processor s 910, 912 to realize all possible 3D data formats that may be used for transmission to output devices and any associated processing therein. In one preferred embodiment the output of each video processor 910, 912 is a 24-bit RGB signal that consists of 8-bits for each color red, green, and blue. To accommodate the color multiplexing feature the switch 906 is capable of routing any color input to any other color output. Therefore the switch 906 serves as a 6-input 6-output matrix switch for 8-bit digital signals. In a preferred embodiment this switch is implemented using a high-speed CPLD integrated circuit.

The microcontroller 904 performs the setup and control functions of the 3D data formatter 902. It uses an EEPROM memory to store register settings for each of the video processors 910, 912 and data switches 904, 906. Microcontroller 904 also may interfaces with user control functions.

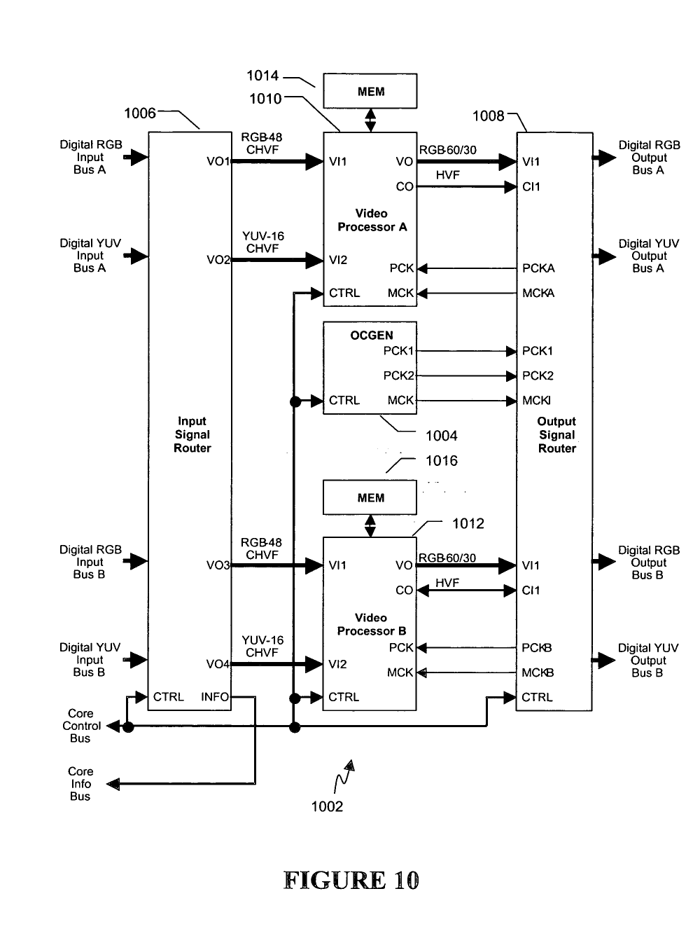

FIG. 10 depicts another embodiment of a 3D data formatter 1002 (which may be used in certain embodiments as 3D date formatter 102 shown in FIG. 1). The 3D data formatter 1002 performs major functions of input channel selection, stereoscopic demultiplexing, stereoscopic image scaling, scan rate conversion, and real time stereoscopic 3D format conversion. In addition to these functions it performs an output channel selection. A microcontroller (not shown) is illustrated as control system 136 of FIG. 1.

An output clock generator 1004 is also depicted. The output clock generator 1004 produces timing signals for the output video stream.

The 3D data formatter 1002 of the present invention includes five major components including the output clock generator 1004 (OCGEN), an input signal router 1006, an output signal router 1008, video processor A 1010, and video processor B 1012. The 3D data formatter system 1002 provides a dual video processor configuration that enables independent image processing for both left and right-perspective image data. The dual-processor configuration provides the highest-image quality available while preventing stereoscopic degradation by keeping left and right image data completely separate. In other embodiments, the dual video processor system enables simultaneous processing of video data for different output 3D formats or video formats.

Each of the video processors 1010, 1012 are video processing circuits with the ability to perform many useful functions including image resizing, scan rate conversion, color correction, keystone correction and many others. Working in parallel the video processors 1010, 1012 are used to realize the useful stereoscopic pan, alignment, zoom, and crop features. These processors 1010, 1012 can control the position in memory of up to plural separate consecutive input image data frames and plural separate output data frames (up to four as shown in FIG. 10). These features make it possible for each video processor 1010, 1012 to operate on a specific set of image data corresponding to the left or right perspective image. This operation constitutes the bases of stereoscopic demultiplexing on the input. Working in conjunction with the input signal router 1006, virtually any conceivable 3D stereoscopic data format may be supported on the input. Once the appropriate stereoscopic image data set has been isolated by the input frame controls, each video processor 1010, 1012 performs the required scaling and image enhancement operations. The video processors 1010, 1012 also act as dual port memory controllers that enable the output data rate to be independent of the input data rate. Input and output data rates are determined by their respective image data timing signals. Preferred embodiments of video processors 1010, 1012 are IP00C715 chips from iChips, Inc. as the major component. Other video processor integrated circuit chips with similar functions and features could also be used. Preferred embodiments of memory blocks 1014, 1016 are 64-megabit SDRAM devices. Sufficient memory is provided to accommodate plural (four as shown in FIG. 10) complete frame buffers for each video processor 1010, 1012 corresponding to the plural frame controls (four as shown in FIG. 10). This configuration provides the maximum control and flexibility required for this system.

The following paragraphs describe some of the more important features accomplished by the video processors 1010, 1012.

Scan rate conversion may be performed by video processors 1010, 1012, whereby the overall picture frame rate (the vertical refresh rate) of the input is changed to a different rage on the output.

Image scaling may be performed by video processors 1010, 1012, whereby a signal format on the input side of the video processor block is transformed to a larger or smaller size signal format on the output side. Many factors control how the image is scaled including whether or not the input or output signal is interlaced, the 3D encoding method, and whether or not 3D mode is on. There are also both linear and nonlinear methods for image scaling.

Whereas image scaling involves the enlargement or reduction of both image data and the signal space, generically, stereoscopic zooming is the enlargement or reduction of a specific rectangular window of the input image within a fixed input signal space to a specific rectangular window of the output image within a fixed output signal space. Zooming functionality may be performed by video processors 1010, 1012. Zoom allows the user to focus and expand a particular area of the image but does not change the format of the output image signal. Zooming on the input side image cause the image to appear larger on the output side. Zooming on the output side causes the image to appear smaller.

Stereoscopic panning may be performed by video processors 1010, 1012, whereby the output 2D or 3D image may be moved vertically or horizontally on the screen. In 3D mode, both stereo channels move together so that the entire stereoscopic image is shifted. This process is different from the alignment process discussed later in that with 3D alignment, stereo channels are moved in opposite directions while keeping the overall image centered. Pan does not affect any scale factors.

Stereoscopic alignment may be performed by video processors 1010, 1012, whereby equal and opposite pan transformations are applied to each video processor chip. This causes each view of the 3D image stream to shift away or towards each other. This feature is very useful in correcting misalignments in stereoscopic camera inputs or dual-projector systems on the output side. It also is useful for moving the zero-parallax point of the image to reduce stereo window violations and to adjust the maximum parallax so that stereoscopic content designed for small screens can be displayed on large screen (or vice versa).

Stereoscopic image cropping may be performed by video processors 1010, 1012, whereby undesirable edges of input and/or output image may be eliminated. This feature is very useful for eliminating stereo window violations or other undesirable portions of the image.

The input signal router 1006 (ISR) is primarily responsible for routing image data and synchronization signals to both video processors 1010, 1012. It also has other functions that help the control system 136 monitor the input video signals and to control the signal decoding hardware. With regard to image data and sync signals, the input signal router 1006 functions as a 2×2 matrix switch. Data input on source channel A (which includes both RGB and YUV data streams for computer and video input respectively) may be routed to either video processor A 1010 or video processor B 1012 or both processors 1010, 1012 at the same time. The same holds true for data input on source channel B. The ISR 1006 also allows independent switching of the input sync signal group (that includes the vertical sync, horizontal sync, and field ID) to the control system 136 via the core info bus 142 for analysis. The timing signal information output control has no effect on the main image output multiplexers. In a preferred embodiment the ISR 1006 also gives the control system 136 the ability to control a Sync-On-Green feature for the RGB source channels separately. The ISR 1006 also handles the selection of the field ID source. In stereoscopic 3D systems the field ID signal is used (especially with frame-sequential formats) to absolutely determine the current stereo field. This field ID signal may be provided external to the RGB connector through a separate stereo-sync input, or it may be provided internal to the RGB connector on pin 12. In the absence of either of these two signals the field ID signal can be generated by the ISR 1006 from the vertical sync input. The ISR 1006 provides the ability to select any of these sources for the field ID signal separately for both source channels. Finally the ISR 1006 aids in the use of alternate pixel sampling mode for high bandwidth RGB inputs by providing signals to both the video processors and to the RGB ADC hardware to identify odd or even pixel capture. This feature also aids in the stereoscopic demultiplexing of column-interleaved 3D. In a preferred embodiment ISR 1006 is implemented using a high-speed field programmable CPLD integrated circuit.

The output signal router (OSR) 1008 is primarily a digital switch used to re-multiplex the separated stereoscopic image streams into the desired 3D format. It also contains and RGB to YUV processor to convert RGB data output from each video processor 1010, 1012 to the YUV format used byte the digital YUV output buses. Under normal circum stances each of the outputs are available at all times, therefore each output can support a completely separate 3D format simultaneously. For the RGB outputs the OSR 1008 is also capable of routing any color data associated with the two input channels to any other color of the two output channels (e.g., swapping the red color data between stereo channels A and B to create anaglyph output). This feature allows the use of color sequential methods for 3D image encoding. In a preferred embodiment this switch is implemented using a high-speed FPGA (field programmable gate array) integrated circuit. This fact allows the device to be updated with new features as they become available. Finally the OSR 1008 is used to route the output pixel clock and memory clock signals from the OCGEN 1004.

The Output Clock Generator 1004 (OCGEN) provides output pixel clock and memory clock signal for both video processors 1010, 1012. The OCGEN 1004 works in conjunction with the OSR 1008 to provide two basic pixel clock configurations including the following:

Configuration 1: the output signal router 1008 routes PCK1 to PCKA and PCK2 to PCKB so that both video processors 1010, 1012 run independent of each other and generate their own output timing signals. This configuration enables the device to output two different signal formats at the same time, which can be useful when the device is used to drive two separate 3D displays (e.g., a primary projection display and an operator monitor). This configuration is also useful for 2D or dual-channel operation; and

Configuration 2: the OSR 1008 routes PCK1 to both PCKA and PCKB. This configuration causes the output of both video processors 1010, 1012 to be mutually synchronized. In this case one video processor 1010 or 1012 acts as a master processor that generates the timing signals for both processors 1010 and 1012. This configuration is the standard configuration for most multiplexed 3D format modes.

In a preferred embodiment of the present invention the 3D data formatter 1002 provides means and an apparatus to accommodate numerous 3D formats from a variety of sources. There are many different methods used by 3D content providers to encode 3D image data into video or computer data formats. Each major 3D format is supported to provide the widest application possible. The major 3D formats supported by the present invention are described below. A representative configuration of the input switch 1006 and the two video processors 1010, 1012 are also described.

Dual-Channel Input 3D Format—The dual channel 3D format involves the transmission of left and right-perspective stereoscopic images on physically separate channels. This format is utilized, for example, when two separate video cameras are combined to make a single stereoscopic camera. The present invention accommodates the dual channel 3D format by configuring the input signal router 1006 to route each input channel to a single separate video processor 1010 or 1012. For instance, if the two video sources are present in digital RGB input bus A and digital RGB input bus B, then bus A is routed to video processor A 1010 and bus B is routed to video processor B 1012. Other combinations are, of course, possible. Another major feature of the present invention that from the fact that two separate video processors 1010, 1012 are used so that both channels of the dual channel 3D format may be synchronized independently of one another. This ability stems from the fact that each input of video processors 1010, 1012 may be driven independently. Synchronization of the two channels occurs at the output of the video processors 1010, 1012.

Frame-Sequential Input 3D Format—Frame-sequential 3D format time-multiplexes the stereo image data based on the vertical sync signal of a computer data output. This means that the 3D field changes at every vertical sync pulse. One way in which the present invention demultiplexes this format is to route the selected input channel to both video processors 1010, 1012. Video processor A 1010 is then configured to process only “even” frames of image data while video processor B 1012 is configured to process only “odd” frames. The use of “even” and “odd” terms is for convenience only since the RGB port of a computer makes no distinction between even and odd image data frames. However, in the case where the computer supports a VESA standard stereo jack, the even and odd frame definitions may be derived from the frame ID signal of the port.

Field-Sequential Input 3D Format—The field-sequential 3D format is very similar to the frame-sequential format but applies to interlaced video signals. In this case the selected channel is routed to both video processors 1010, 1012 as in the previous case. Since many video formats (e.g., NTSC, PAL, etc.) distinguish between even and odd fields of each frame of video data, it is possible for the video processors 1010, 1012 to process only even or odd fields of each video frame.

Row-Interleaved Input 3D Format—The row-interleaved 3D format is another RGB computer format that multiplexes stereoscopic image data based on the horizontal sync signal. This results in a row-by-row multiplexing pattern. One of several methods by which the present invention may demultiplex the row interleaved 3D format is to route the single input to both video processors 1010, 1012 and then set the memory control registers of each video processor 1010, 1012 such that only odd or only even rows are available for processing. Another method is to setup the input signal router 1006 to route the selected input channel to both video processors 1010, 1012 in such a way that rows that are not to be processed are blanked out. For instance if video processor A 1010 is to operate on information encoded on the even lines, then the input signal router 1006 will blank out the odd lines. No matter the method used to demultiplex the row-interleaved format images, each video processor 1010, 1012 will apply a base scale factor of 2 in the vertical direction to restore the images to full height. Other scale factors may be applied to format the resulting image to the native resolution of the display.

Over-Under Input 3D Format—The over-under 3D format encodes left and right stereoscopic image data into the top and the bottom half of each image frame. For instance one over-under method encodes right-perspective data in the top half and left-perspective data in the bottom half of each image frame. One of the ways the present invention may demultiplex over-under 3D format data is to route the selected input to both video processors 1010, 1012 and then set the memory control registers such that video processor A 1010 operates on the top half of each frame only and video processor B 1012 operates on the bottom half of each frame. Other methods are also possible. Finally, each video processors 1010, 1012 will apply a base scale factor of 2 in the vertical direction to restore the images to full height. Other scale factors may be applied to format the resulting image to the native resolution of the display.

Side-by-Side Input 3D Format—The side-by-side 3D format encodes left and right perspective image data on the left and right sides of each image frame. As in the previous cases, one method by which the present invention demultiplexes stereoscopic information in this format is to route the selected channel to both video processors 1010, 1012. The memory control registers for each video processor 1010, 1012 are then configured such that video processor A 1010 operates on only the left side of each frame and video processor B 1012 operates on the right side of each frame. Similar to the previous single-channel formats, each video processor 1010, 1012 will apply a base scale factor of 2 in the horizontal direction to restore the images to full width and maintain the proper aspect ratio. Other scale factors may be applied to format the resulting image to the native resolution of the display.

Column-Interleaved Input 3D Format—The column interleaved 3D format encodes left and right perspective image data on alternating columns of the image frame. This format corresponds to a change in the 3D field for every pixel clock pulse. As in the previous cases the present invention provides several options for demultiplexing this type of 3D format including blanking columns of data on the input pixel clock or by routing the select channel to both video processors 1010, 1012 and then setting memory control registers such that only even or odd columns are processed.

Just as the 3D data formatter 1002 is capable of receiving 3D data in many different format, so too can it transmit processed 3D data in one of the many different 3D formats. To provide the widest range of possibilities, a preferred embodiment of the present invention provides a means and apparatus to support all of the following 3D data formats for transmission of 3D stereoscopic information from the 3D Data Formatter to the desired output(s).

Dual-Channel Output 3D Format—The OSR 1008 passes the output from each video processor to its corresponding output or to opposite outputs.

Frame-Sequential Output 3D Format—The OSR 1008 encodes left and right perspective image data on alternate frames of the output signal by switching the source of each Digital Output Bus between the two video processors 1010, 1012 on a frame-by-frame basis using the output vertical sync signal as the reference for the switch.

Field-Sequential Output 3D Format The OSR 1008 encodes left and right perspective image data on alternate fields of the interlaced output signal by switching the source of each digital output bus between the two video processors 1010, 1012 on a field-by-field basis using the output vertical sync signal as a reference for the switch.

Over-Under Output 3D Format—The OSR 1008 encodes left and right perspective image data in a single image frame by encoding one perspective image in the top half and the other in the bottom half of each frame. This action is accomplished by switching the source of each digital output bus between the two video processors 1010, 1012 using a top-bottom identification signal generated from the vertical sync. This signal has the same frequency as the vertical sync signal but with a base duty cycle of 50% modified according to the front and back porch. This signal is generated and used inside the OSR 1008.

Side-by-Side Output 3D Format—The OSR 1008 encodes left and right perspective image data in a single image frame by encoding one perspective image in the left side and the other in the right side of each frame. This action is accomplished by switching the source of each digital output bus between the two video processors 1010, 1012 using a left-right side identification signal generated from the horizontal sync. This signal has the same frequency as the vertical sync signal but with a duty cycle adjusted to center the switching midway during the visible image. This signal is generated and used inside the OSR 1008.

Row-Interleaved Output 3D Format—The OSR 1008 encodes left and right perspective image data in a single image frame by encoding one perspective image in the even rows and the other in the odd rows of each frame. This action is accomplished by switching the source of each digital output bus between the two video processors 1010, 1012 using a line identification signal generated from the horizontal sync. The line identification signal is a 50% duty cycle signal with half the frequency of the horizontal sync. It is generated and used inside the OSR 1008.

Column-Interleaved Output 3D Format—The OSR 1008 encodes left and right perspective image data in a single image frame by encoding one perspective image in the even columns and the other in the odd columns of each frame. This action is accomplished by switching the source of each digital output bus between the two video processors 1010, 1012 using a pixel identification signal generated from the pixel clock. The pixel identification signal is a 50% duty cycle signal with half the frequency of the pixel clock. It is generated and used inside the OSR 1008.

Color Swapped Dual Channel Output 3D Format—This format is similar to the dual-channel format except that one or two colors are swapped between the views. This format is useful for providing the green-swapped dual channel format used by the device described in commonly owned U.S. patent application Ser. No. 09/772128 filed Jan. 29, 2001 entitled “System And Method For Displaying 3d Imagery Using A Dual Projector 3d Stereoscopic Projection System,”, which is incorporated by reference herein.

In addition, each of the 3D data transmissions formats may be used in either an input synchronization mode or an output synchronization mode. Input synchronization mode refers to data output from the 3D data formatter 1002 being synchronized to the external 3D signals that are input to the device. Output synchronization mode refers to data output from the 3D data formatter 1002 being synchronized independently of the external 3D input signals. The output synchronization rate is set internally by the OCGEN 1004.

The implementations of 3D format conversion systems as illustrated above are merely exemplary. It is understood that other implementations will readily occur to persons with ordinary skill in the art. All such implantations and variations are deemed to be within the scope and spirit of the present invention as defined by the accompanying claims.

What is claimed is:

1. A stereoscopic format conversion system comprising:
a plurality of front end processing systems;
a 3D data formatter for performing real-time conversion of one of a plurality of input 3D formats to one of a plurality of output 3D formats;
a plurality of back-end processors; and
a control system.

2. A method of performing stereoscopic format conversion comprising:
inputting a 3D data stream from one or more of a plurality of 3D formats;
processing said 3D data;
performing real time 3D data format conversion to produce format converted data;
processing said format converted data for outputting to produce a converted 3D data stream; and
outputting converted 3D data stream.

3. A stereoscopic format conversion system comprising:
a front end processing system and a front end expansion port;
a 3D data formatter for performing real-time conversion of one of a plurality of input 3D formats to one of a plurality of output 3D formats;
a back-end processor and a back end expansion port; and
a control system.

4. A method of performing stereoscopic format conversion comprising:
inputting a 3D data stream from a plurality of 3D formats;
processing said 3D data stream at a front end processor or a processor added to a front end expansion port;
performing real time 3D data format conversion to produce format converted data;
processing said format converted data to produce a converted 3D data stream for outputting at a back end processor or a processor added to a back end expansion port; and
outputting converted 3D data stream, wherein said stereoscopic format conversion method performs conversion of a plurality of 3D formats to any one of said plurality of said 3D formats.

5. A stereoscopic format conversion system comprising:
a front end processing system;
a 3D data formatter for performing real-time conversion of one of a plurality of input 3D formats to one of a plurality of output 3D formats;
a back-end processor; and
a control system,
wherein the 3D data formatter converts stereoscopic video and performs a real time function selected from the group consisting of stereoscopic image pan, alignment, crop, zoom, keystone correction, aspect ratio conversion, linear scaling, non-linear scaling, scan-rate conversion, and any combination comprising at least one of the foregoing functions.

6. A stereoscopic format conversion system comprising:
a front end processing system for processing from one or more of plural 3D input formats;
a 3D data formatter for performing real-time conversion of one of a plurality of input 3D formats to one of a plurality of output 3D formats;
a back-end processor for processing to one or more of plural 3D output formats; and
a control system,
wherein the one or more 3D input formats and the one or more 3D output formats may be independently selected from the group of formats consisting of standard 2D; dual-channel; field-sequential; frame-sequential (page-flipped); over-under; row-interleaved; side-by-side; column-interleaved, spectrally multiplexed, and combinations comprising at least one of the foregoing formats.
